(19) United States
(12) Patent Application Publication
(10) Pub. No.: US 2026/0057302 A1
(43) Pub. Date: Feb. 26, 2026

(54) DATA INTEGRATION SYSTEM

(71) Applicant: TechCollect LLC, Rochester, MI (US)

(72) Inventors: Jacqueline Galofaro, Rochester Hills, MI (US); Gar Liebler, Oakland, MI (US); John Cronin, Jericho, VT (US)

(21) Appl. No.: 19/309,438

(22) Filed: Aug. 25, 2025

Related U.S. Application Data
(60) Provisional application No. 63/686,529, filed on Aug. 23, 2024.

(51) Int. Cl. G06N 20/00

(52) U.S. Cl. CPC G06N 20/00

(57) ABSTRACT

This invention pertains to a method for integrating non-financial data with financial analysis systems to enhance decision-making processes. The system includes a property management web portal that displays and extracts real estate data, combined with a financial management module and an accounts payable service module. It processes non-financial collection data through a specialized module that interacts with property management data to generate actionable insights. An action module uses these insights to adjust financial accounts or billing processes automatically. This integration allows for more nuanced financial management and responsiveness to non-financial indicators, enhancing financial accuracy and operational efficiency.

### CROSS-REFERENCE TO RELATED APPLICATION

This application claims the priority benefit of U.S. provisional patent application No. 63/686,529 filed Aug. 23, 2024, which is incorporated by reference herein in their entirety.

### BACKGROUND

### Field of the Invention

The present disclosure is generally related to integrating disparate data structures to enhance decision-making processes.

### Description of the Related Art

Currently, property management companies face challenges in optimizing performance and operational efficiency due to the lack of integration between different data sources. There is a need for a method to seamlessly integrate non-financial collection data with financial analysis systems to enhance decision-making processes and improve overall financial accuracy. Also, community associations such as condominiums and HOAs, encounter difficulties in accurately predicting future revenue streams and identifying cost-saving opportunities due to siloed data sources (e.g., of financial and non-financial data stored in different types of data structures). Property owners and managers encounter challenges in effectively managing cash flow and optimizing financial accounts due to the fragmented nature of their data sources. Lastly, Property managers seek a method to proactively identify potential risks and opportunities within their portfolios by analyzing both financial and non-financial data. The current lack of integration between property management data and non-financial collection data hinders the ability to generate actionable insights for optimizing financial accounts and billing processes. Thus, there is a need in the prior art to provide a method of integrating financial and non-financial data to enhance decision-making processes.

### SUMMARY OF THE CLAIMED INVENTION

Embodiments of the present invention may include a method and a non-transitory computer-readable storage medium having embodied thereon a program executable by a processor to perform a method for integrating disparate data structures. The method includes storing a plurality of rules and corresponding actions to the rules, receiving data of a user account over a communication network, extracting one or more features from the received data, wherein the features are associated with threshold conditions, analyzing the received data using recursive modeling to predict a label associated with the account based on the extracted features achieving the threshold conditions, comparing the label of the analyzed data to the stored rules, and executing an action based on the comparison, wherein the action includes automatically adjusting a current plan of the user account.

Embodiments of the present invention further includes a system for integrating disparate data structures. The system includes memory that stores a plurality of rules and corresponding actions to the rules, a communication interface that communicates over a communication network to receive data of a user account, and a processor that executes instructions stored in memory, wherein the processor executes the instructions to extract one or more features from the received data, wherein the features are associated with threshold conditions, analyze the received data using recursive modeling to predict a label associated with the account based on the extracted features achieving the threshold conditions, compare the label of the analyzed data to the stored rules, and execute an action based on the comparison, wherein the action includes automatically adjusting a current plan of the user account.

### DESCRIPTIONS OF THE DRAWINGS

FIG. 1 illustrates an integrating financial and non-financial data, according to an embodiment.

FIG. 2 illustrates a Base Module, according to an embodiment.

FIG. 3 illustrates an Accounting Module, according to an embodiment.

FIG. 4 illustrates an Accounts module, according to an embodiment.

FIG. 5 illustrates a Non-Financial Module, according to an embodiment.

FIG. 6 illustrates an Interaction Module, according to an embodiment.

FIG. 7 illustrates an Action Module, according to an embodiment.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

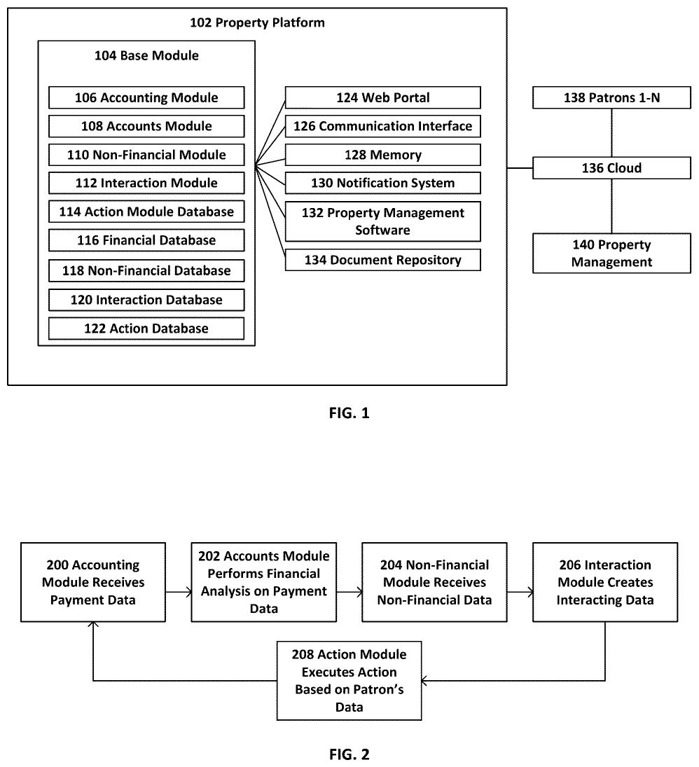

FIG. 1 illustrates a method for integrating financial and non-financial data. This method comprises a property platform 102, which may be a web-based application system designed to optimize property management operations by integrating financial and non-financial data streams. The property platform 102 may contain a plurality of interconnected modules, the property platform 102 may enable enhanced decision-making processes through a combination of real estate data visualization, financial analysis, and automated action functionalities. The property platform 102 may encompass a web portal 124, facilitating user access to pertinent real estate data, including occupancy rates, income, and maintenance schedules. Additionally, the property platform may incorporate an accounting module 106 for managing financial transactions, budgeting, and reporting, as well as an Accounts module 108 to streamline invoice processing and payment workflows. The property platform 102 may include a non-financial module 110 that collects and organizes non-financial data such as patron 138 employment statuses, occupancy changes, property issues, etc. Interactions between these modules may be facilitated by an interaction module 112 to create interacting data based on the financial data and non-financial data of each patron 138. Based on these interacting data points, the action module 114 may trigger automated adjustments to financial accounts or billing processes, thereby optimizing operational efficiency and financial accuracy. The property platform 102 may be include computing clusters and storage partitions that scale up as data needs and associated accounts grow.

Further, embodiments may include a base module 104, which initiates the accounting module 106, Accounts module 108, non-financial module 110, interaction module 112, and the action module 114.

Further, embodiments may include an accounting module 106, which begins by being initiated by the base module 104. The patron 138 logs onto the web portal 124. The accounting module 106 receives the payment from the patron 138. The accounting module 106 stores the patron's 138 payment data in the financial database 116. The accounting module 106 returns to the base module 104.

Further, embodiments may include an Accounts module 108, which begins by being initiated by the base module 104. The Accounts module 108 filters the financial database 116 on the first patron 138. The Accounts module 108 performs the financial analysis on the patron's 138 data. The Accounts module 108 stores the analysis data in the financial database 116. The Accounts module 108 determines if there are more patrons 138 remaining in the financial database 116. If it is determined that there are more patrons 138 remaining in the financial database 116 the Accounts module 108 filters the financial database 116 on the next patron 138, and the process returns to performing the financial analysis on the patron's 138 data. If it is determined that there are no more patrons 138 remaining in the financial database 116, the Accounts module 108 returns to the base module 104.

Further, embodiments may include a non-financial module 110, which begins by being initiated by the base module 104. The patrons 138 log onto the web portal 124. The non-financial module 110 receives the non-financial data from patron 138. The non-financial module 110 stores the non-financial data in the non-financial database 118. The non-financial module 110 returns to the base module 104.

Further, embodiments may include an interaction module 112, which begins by being initiated by the base module 104. The interaction module 112 filters the financial database 116 on the first patron 138. The interaction module 112 extracts the patron's 138 data from the financial database 116. The interaction module 112 filters the non-financial database 118 on the extracted patron's 138 ID from the financial database 116. The interaction module 112 extracts the patron's 138 non-financial data from the non-financial database 118. The interaction module 112 creates the interacting data for the patron 138. The interaction module 112 stores the interacting data in the interaction database 120. The interaction module 112 determines if there are more patrons 138 remaining in the financial database 116. If it is determined that there are more patrons 138 remaining in the financial database 116 the interaction module 112 filters the financial database 116 on the next patron 138. If it is determined that there are no more patrons 138 remaining in the financial database 116 the interaction module 112 returns to the base module 104.

Further, embodiments may include an action module 114, which begins by being initiated by the base module 104. The action module 114 filters the interaction database 120 on the first patron 138. The action module 114 extracts the patron's 138 data from the interaction database 120. The action module 114 compares the extracted data to the action database 122. The action module 114 determines if there is a corresponding action. If it is determined that there is a corresponding action in the action database 122, the action module 114 extracts the corresponding action. The action module 114 executes the corresponding action. If it is determined that there is not a corresponding action or after the extracted corresponding action has been executed, the action module 114 determines if there are more patrons 138 remaining in the interaction database 120. If it is determined that there are more patrons 138 remaining in the interaction database 120, the action module 114 filters the interaction database 120 on the next patron 138 and the process returns to extracting the patron's 138 data from the interaction database 120. If it is determined that there are no more patrons 138 remaining in the interaction database 120 the action module 114 returns to the base module 104.

Further, embodiments may include a financial database 116, which may be a database created in the process described in the accounting module 106 and the Accounts module 108 in which the patron's 138 finances are collected and/or calculated. The financial database 116 may contain the patron's 138 financial information, such as the patron ID, first name, last name, address, home equity, the estimated value of the home, the patron's monthly invoices stored as a data file, the patron's payment history, and the patron's account status. In some embodiments, the financial database 116 may contain the patron's city, state, zip code, disposable income, liquid assets, income, debt range, debt utilization, etc.

Further, embodiments may include a non-financial database 118, which may be a database created in the process described in the non-financial module 110 in which the patron's 138 non-financial is collected. The non-financial database 118 may contain the patron's 138 non-financial information, such as the patron ID, first name, last name, address, number of adults, number of children, age, employment status, if the patron 138 has a property complaint, if there has a been a change in occupancy, etc. In some embodiments, the non-financial database 118 may include education level, patron's 138 middle initial, phone number, political party affiliation, if the Patron 138 responds to emails, phone calls, or texts, the patron's 138 email address, social media avatars, social media profiles, such as LinkedIn, Facebook, Instagram, etc., if the patron 138 owns an RV, the number of vehicles, age, family size, years of employment, etc.

Further, embodiments may include an interaction database 120, which may be created during the process described in the interaction module 112 in which a financial data point and non-financial data point are used to create interacting data that is used in the action module 114 to determine if there should be an adjustment to the patron's 138 payments or account. The interaction database 120 may include the patron's ID, the financial data point, the non-financial data point, and the interacting data point. In some embodiments, the financial data point may be the patron's 138 home equity, the estimated value of the home, the patron's monthly invoices stored as a data file, the patron's payment history, the patron's 138 account status, disposable income, liquid assets, income, debt range, debt utilization, etc. In some embodiments, the non-financial data point may be number of adults, number of children, age, employment status, if the patron 138 has a property complaint, if there has a been a change in occupancy, education level, patron's 138 middle initial, phone number, political party affiliation, if the Patron 138 responds to emails, phone calls, or texts, the patron's 138 email address, social media avatars, social media profiles, such as LinkedIn, Facebook, Instagram, etc., if the patron 138 owns an RV, the number of vehicles, age, family size, years of employment, etc.

Further, embodiments may include an action database 122, which may be a previously created or existing database that contains a plurality of rules that are used in the action module 114 to determine if there is a corresponding action or notification that needs to be sent to a patron 138. The action database 122 may contain a rule ID, the rule, and the corresponding action. The rules may be used to determine if there is a potential issue with a patron's 138 account based on the interacting data created in the interaction module 112 and provide an action to adjust the patron's 138 payment plan, send a notification, expedite maintenance on the property, etc. In some embodiments, the rules may be based on the specific situation that the Patron 138 is experiencing. In some embodiments, the rules may adjust the payment plan of the patron 138 to provide financial flexibility depending on the patron's 138 current situation. In some embodiments, the corresponding actions may range from no action, extending the payment plan, waiving the payments required by the patron 138, to determining how the patron 138 is contacted. For example, if the patron's 138 interacting data is that they recently lost their job or employment, based on the patron 138 account balance is outstanding and they are unemployed, the action may be to extend the payment plan by three months. If the patron's 138 interacting data is that they recently retired, based on the patron's 138 age and reduction of income, and has a recent late payment, the action may be to contact the patron 138 about their payment plan due to the lifestyle change. If the patron's 138 interacting data is that they recently separated from the partner, based on their account status being up-to-date and a change in occupancy at the property, the action may be to extend the payment plan by five months. If the patron's 138 interacting data is that their account is satisfactory, meaning payments are up-to-date, and there is no change in non-financial data, then the corresponding action may be no action.

Further, embodiments may include a web portal 124, which may be a web-based application or website that serves as a single point of access for users to access information, services, and resources. The web portal 124 may allow patrons 138 to securely log in and access features such as rent payment, communication with property management 140, maintenance request submission, access to documents, community forums, and other relevant functionalities. The web portal 124 may be designed for property management and may consist of various components and features integrated into a cohesive interface accessible via a web browser. In some embodiments, the web portal 124 may include user authentication that requires users, such as patrons 138, to authenticate themselves through secure login credentials, for example, username, password, multi-factor authentication, etc. In some embodiments, the web portal 124 may include a dashboard, which may display relevant information such as upcoming rent payments, maintenance request status, announcements, and notifications. In some embodiments, the web portal 124 may include a rent payment module, which may be a dedicated section that allows patrons 138 to view their rent balance, make payments using various methods, such as credit/debit cards, ACH transfers, etc., set up recurring payments, view payment history and generate receipts. In some embodiments, the web portal 124 may include a communication hub, which enables direct messaging between patrons 138 and property management 140 staff for inquiries, complaints, or general communication and may support sending announcements, alerts, and updates to all patrons 138. In some embodiments, the web portal 124 may include a complaint management system, which allows patrons 138 to submit maintenance requests or complaints through a user-friendly interface, tracks the status of requests, assigns tasks to maintenance staff, and provides updates to patrons. In some embodiments, the web portal 124 may include property updates and notifications by displaying announcements, news, and updates regarding the property, community events, maintenance schedules, etc., through push notifications or email alerts to patrons 138 for important developments. In some embodiments, the web portal 124 may include HOA member feedback and survey forms for patrons 138 to provide input on their living experience and suggest improvements. In some embodiments, the web portal 124 may include account management, which allows patrons 138 to manage their profiles, update personal information, view transaction history, and provide a log of past interactions and activities within the portal. In some embodiments, the web portal 124 may be integrated with the property management software 132 to synchronize data, streamline administrative processes, and ensure real-time updates and data consistency across systems.

Further, embodiments may include a communication interface 126, which may be a hardware or software component that enables communication between two or more electronic devices or systems. The communication interface 126 may include a set of protocols, rules, and standards that define how information is transmitted and received between the devices. The communication interface 126 may be a physical connector, wireless network, or software application and may include components such as drivers, software libraries, and firmware that may be used to control and manage the communication process. In some embodiments, the communication interface 126 may be compatible with USB, Bluetooth, or Wi-Fi. The communication interface 126 may communicate with a network. Examples of networks may include, but are not limited to, the Internet, a cloud network, a Wireless Fidelity (Wi-Fi) network, a Wireless Local Area Network (WLAN), a Local Area Network (LAN), a telephone line (POTS), Long Term Evolution (LTE), and/or a Metropolitan Area Network (MAN).

Further, embodiments may include a memory 128, which may include suitable logic, circuitry, and/or interfaces that may be configured to store a machine code and/or a computer program with at least one code section executable by the processor. Examples of implementation of the memory 128 may include, but are not limited to, Random Access Memory (RAM), Read Only Memory (ROM), a Hard Disk Drive (HDD), and/or a Secure Digital (SD) card.

Further, embodiments may include a notification system 130, which may be a software component or service that enables the generation, management, and delivery of notifications to users based on specific triggers or events within an application or system. The notification system 130 may handle the dissemination of various types of notifications, such as rent payment reminders, maintenance request updates, announcements, and emergency alerts, to patrons 138 and property management 140 personnel through multiple communication channels. The notification system 130 may be designed to ensure effective communication and timely dissemination of information to relevant stakeholders. In some embodiments, the notification system 130 may be configured to monitor specific events or triggers within the property platform 102, such as rent due dates, maintenance request submissions, or new announcements. In some embodiments, the notification system 130 may generate the corresponding notification based on predefined templates and rules, including text messages, emails, push notifications to mobile devices, or in-app alerts. In some embodiments, the notification system 130 may determine the recipients of each notification based on predefined criteria, such as the patrons 138 associated with a particular property, property management 140 staff responsible for handling maintenance requests, or all patrons 138 within a specific community. In some embodiments, the notification system 130 may select the appropriate delivery channels for each notification, including email, SMS/text messaging, mobile app push notifications, and in-app alerts. In some embodiments, the notification system 130 may allow notifications to be personalized with relevant details, such as the patron's name, property address, or specific information related to the event triggering the notification. In some embodiments, the notification system 130 may allow for the scheduling of notifications to be sent at specific times or intervals, ensuring that they reach recipients at appropriate times. In some embodiments, real-time notifications may also be triggered immediately upon the occurrence of time-sensitive events, such as emergency alerts or critical updates. In some embodiments, the notification system 130 may track the delivery status of each notification, including successful deliveries, failures, and recipient responses. In some embodiments, the notification system 130 may seamlessly integrate with the property platform 102, enabling it to access relevant data and trigger notifications based on real-time events and updates within the system.

Further, embodiments may include property management software 132, which may be a cloud-based or on-premise software application that facilitates the management of residential or commercial properties by automating processes such as HOA member screening, lease/HOA management, rent/HOA payment collection, maintenance tracking, and financial reporting. The property management software 132 may serve as a centralized platform for property management 140, landlords, and patrons 138 to manage and access property-related information and perform various tasks. In some embodiments, the property management software 132 may store Patron 138 information, including contact details, lease agreements, rental history, and payment records. In some embodiments, the property management software 132 may allow property management 140 to easily add, edit, or terminate patron leases and provides tools for Patron 138 screening and background checks during the application process. In some embodiments, the property management software 132 may manage lease agreements, including lease terms, renewal dates, rental rates, and security deposits. In some embodiments, the property management software 132 may facilitate rent collection through various payment methods, including online payments, ACH transfers, and credit card processing. In some embodiments, the property management software 132 may track rent payments, late fees, and outstanding balances. In some embodiments, the property management software 132 may generate financial reports, such as income statements, balance sheets, and rent roll summaries. In some embodiments, the property management software 132 may log maintenance requests submitted by patrons and track their status from submission to completion. In some embodiments, the property management software 132 may store and organize property-related documents, such as lease/HOA agreements, inspection reports, insurance policies, and occupant communications.

Further, embodiments may include a document repository 134, which may be a software component or service within a property platform 102 that provides a centralized location for storing, managing, and accessing property-related documents and files. The document repository 134 may be a database or file system to securely store documents, along with metadata and indexing capabilities for efficient organization and retrieval. The document repository 134 may support features such as document upload, version control, access control, search functionality, and integration with other modules of the property management platform. The document repository 134 may be a digital archive for storing and managing a wide range of property-related documents and files.

Further, embodiments may include a cloud 136 or a communication network, which may be a wired and/or wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over the Internet, and relies on the sharing of resources to achieve coherence and economies of scale, like a public utility, while third-party clouds enable organizations to focus on their core businesses instead of expending resources on computer infrastructure and maintenance. The property platform 102 and the components of the property platform 102, such as web portal 120, may communicate with the patrons 134 and the property management software 136 via the cloud 132.

Further, embodiments may include a plurality of patrons 138, who may be members of a homeowners association, or HOA, that are the individuals who own property within the community governed by the association. They are bound by the rules, regulations, and financial obligations set forth by the HOA's governing documents, which usually include articles of incorporation, bylaws, covenants, conditions, and restrictions. In some embodiments, the patrons 138 may have voting rights and may participate in HOA meetings and decision-making processes. The patrons 138 may be responsible for paying HOA fees and adhering to the community's rules and regulations. In some embodiments, the plurality of patrons 138 may refer to entities associated with rental agreements for residential or commercial properties. Patrons 138 may be represented as records within the software's database and are characterized by attributes such as personal information, lease terms, rental history, payment records, and contact details. The property platform 102 enables property management 140 to manage occupant information, track lease/HOA agreements, monitor rent?HOA payments, communicate with occupant, and address maintenance requests and issues.

Further, embodiments may include property management 140, who may be individuals or entities responsible for the day-to-day operations, financial management, Patron 138 relations, and maintenance of rental properties. property management 140 may involve tasks such as lease management, rent collection, maintenance coordination, patron screening, property marketing, and financial reporting. In some embodiments, property managers may utilize the property platform 102 to streamline workflows, automate processes, and efficiently manage various aspects of property management.

FIG. 2 illustrates the base module 104. The process begins with the base module 104 initiating, at step 200, the accounting module 106. For example, the accounting module 106 begins by being initiated by the base module 104. The patron 138 logs onto the web portal 124. The accounting module 106 receives the payment from the patron 138. The accounting module 106 stores the patron's 138 payment data in the financial database 116. The accounting module 106 returns to the base module 104. The base module 104 initiates, at step 202, the Accounts module 108. For example, Accounts module 108 begins by being initiated by the base module 104. The Accounts module 108 filters the financial database 116 on the first patron 138. The Accounts module 108 performs the financial analysis on the patron's 138 data. The Accounts module 108 stores the analysis data in the financial database 116. The Accounts module 108 determines if there are more patrons 138 remaining in the financial database 116. If it is determined that there are more patrons 138 remaining in the financial database 116 the Accounts module 108 filters the financial database 116 on the next patron 138, and the process returns to performing the financial analysis on the patron's 138 data. If it is determined that there are no more patrons 138 remaining in the financial database 116, the Accounts module 108 returns to the base module 104. The base module 104 initiates, at step 204, the non-financial module 110. For example, the non-financial module 110 begins by being initiated by the base module 104. The patrons 138 log onto the web portal 124. The non-financial module 110 receives the non-financial data from patron 138. The non-financial module 110 stores the non-financial data in the non-financial database 118. The non-financial module 110 returns to the base module 104. The base module 104 initiates, at step 206, the interaction module 112. For example, the interaction module 112 begins by being initiated by the base module 104. The interaction module 112 filters the financial database 116 on the first patron 138. The interaction module 112 extracts the patron's 138 data from the financial database 116. The interaction module 112 filters the non-financial database 118 on the extracted patron's 138 ID from the financial database 116. The interaction module 112 extracts the patron's 138 non-financial data from the non-financial database 118. The interaction module 112 creates the interacting data for the patron 138. The interaction module 112 stores the interacting data in the interaction database 120. The interaction module 112 determines if there are more patrons 138 remaining in the financial database 116. If it is determined that there are more patrons 138 remaining in the financial database 116 the interaction module 112 filters the financial database 116 on the next patron 138. If it is determined that there are no more patrons 138 remaining in the financial database 116 the interaction module 112 returns to the base module 104. The base module 104 initiates, at step 208, the action module 114. For example, the action module 114 begins by being initiated by the base module 104. The action module 114 filters the interaction database 120 on the first patron 138. The action module 114 extracts the patron's 138 data from the interaction database 120. The action module 114 compares the extracted data to the action database 122. The action module 114 determines if there is a corresponding action. If it is determined that there is a corresponding action in the action database 122, the action module 114 extracts the corresponding action. The action module 114 executes the corresponding action. If it is determined that there is not a corresponding action or after the extracted corresponding action has been executed, the action module 114 determines if there are more patrons 138 remaining in the interaction database 120. If it is determined that there are more patrons 138 remaining in the interaction database 120, the action module 114 filters the interaction database 120 on the next patron 138, and the process returns to extracting the patron's 138 data from the interaction database 120. If it is determined that there are no more patrons 138 remaining in the interaction database 120 the action module 114 returns to the base module 104.

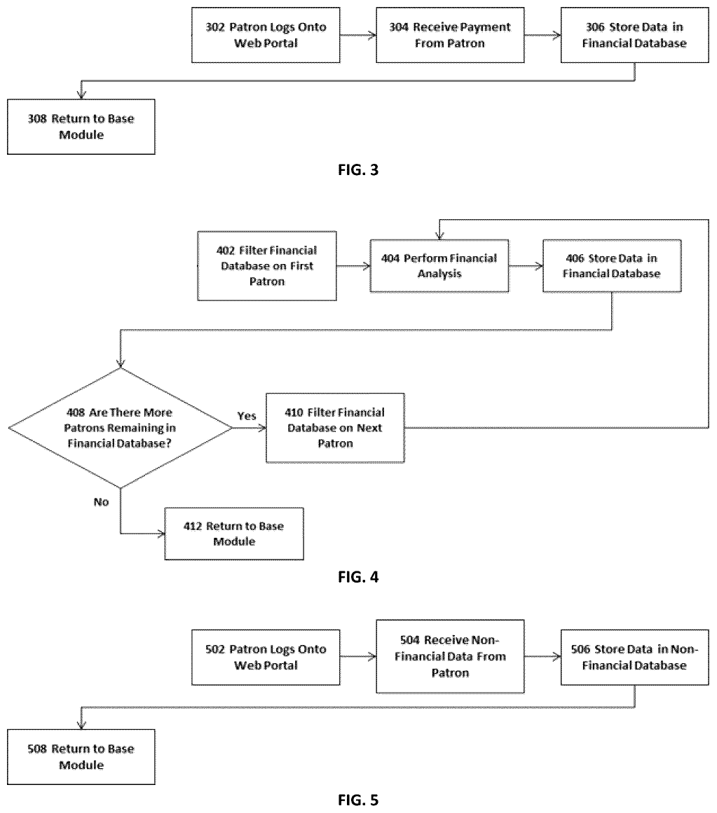

FIG. 3 illustrates the accounting module 106. The process begins with accounting module 106 being initiated by the base module 104. In some embodiments, the accounting module 106 may be continuously polling for a patron 138 to log in to send a financial payment to the property platform 102. The patron 138 logs, at step 302, onto the web portal 124. In some embodiments, the web portal 124 may allow patrons 138 to securely log in and access features such as rent payment, communication with property management 140, maintenance request submission, access to documents, community forums, and other relevant functionalities. In some embodiments, the web portal 124 may include a rent payment module, which may be a dedicated section that allows patrons 138 to view their rent balance, make payments using various methods, such as credit/debit cards, ACH transfers, etc., set up recurring payments, view payment history and generate receipts. The accounting module 106 receives, at step 304, the payment from patron 138. In some embodiments, the accounting module 106 may receive real-estate data from the patron 138, including home equity, home estimated value, the income of the patron 138, the number of patrons 138 per property, the patron ID, the first and last name of the patron 138, the property address, etc. In some embodiments, the first time a patron 138 logs into the web portal 124 or signs up through the web portal 124, the patron 138 may be required to send additional financial and real-estate data that is collected and stored in the document repository 134 to be used by the property platform 102. The accounting module 106 stores, at step 306, the patrons 138 payment data in the financial database 116. The financial database 116 may contain the patron's 138 financial information, such as the patron ID, first name, last name, address, home equity, the estimated value of the home, the patron's monthly invoices stored as a data file, the patron's payment history, etc. In some embodiments, the financial database 116 may contain the patron's city, state, zip code, disposable income, liquid assets, income, debt range, debt utilization, etc. The accounting module 106 returns, at step 308, to the base module 104.

FIG. 4 illustrates the Accounts module 108. The process begins with the Accounts module 108 being initiated by the base module 104. The Accounts module 108 filters, at step 402, the financial database 116 on the first patron 138. The Accounts module 108 may filter the financial database 116 on the first patron 138 so that the financial database 116 displays the individual patron's 138 data, such as first name, last name, address, home equity, the estimated value of the home, the patron's monthly invoices stored as a data file, and the patron's 138 payment history. The Accounts module 108 performs, at step 404, the financial analysis on the patron's 138 data. For example, the financial analysis may be an algorithm that determines the patron's 138 account status, such as delinquency, late, outstanding balance, up-to-date or current, etc. The financial analysis may utilize variables from the financial database 116, including the payment history data file which may include total payments and last payment date, and may iterate through the payment history records to calculate the aggregate sum of payments, accumulating in total payments. The financial analysis then compares the date of the last recorded payment with the current date to determine if it surpasses the agreed-upon payment interval. If the elapsed time exceeds said interval, the account is marked as delinquent due to a recent payment lapse. Further, the financial analysis may compare the total payments against the amount owed for the corresponding period. Should the former fall short of the latter, indicating underpayment, the account is designated as delinquent due to an outstanding balance. The financial analysis may flag or mark the account for additional scrutiny or action if deemed delinquent or designate it as current if payments are deemed current. The Accounts module 108 stores, at step 406, the analysis data in the financial database 116. The Accounts module 108 may store the financial analysis data, such as the patron's 138 account status, in the financial database 116, which may be up-to-date or current, delinquent late fee, delinquent outstanding balance, delinquent multiple missed payments, etc. The Accounts module 108 determines, at step 408, if there are more patrons 138 remaining in the financial database 116. The Accounts module 108 may filter the financial database 116 on each patron 138 to ensure that each patron's 138 account has the financial analysis performed to store the account status of each patron 138 in the financial database 116. If it is determined that there are more patrons 138 remaining in the financial database 116, the Accounts module 108 filters, at step 410, the financial database 116 on the next patron 138, and the process returns to performing the financial analysis on the patron's 138 data. If it is determined that there are no more patrons 138 remaining in the financial database 116 the Accounts module 108 returns, at step 412, to the base module 104.

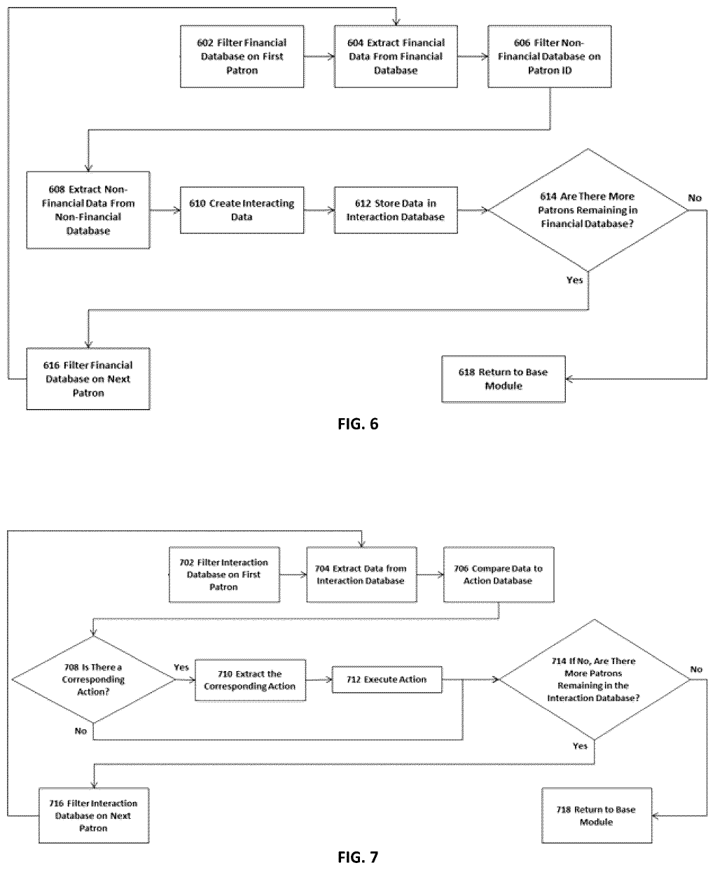

FIG. 5 illustrates the non-financial module 110. The process begins with the non-financial module 110 being initiated by the base module 104. In some embodiments, the non-financial module 110 may be continuously polling for a patron 138 to log in to send non-financial data to the property platform 102. The patrons 138 logs, at step 502, onto the web portal 124. The web portal 124 may be designed for property management and may consist of various components and features integrated into a cohesive interface accessible via a web browser. In some embodiments, the web portal 124 may include user authentication that requires users, such as patrons 138, to authenticate themselves through secure login credentials, for example, username, password, multi-factor authentication, etc. In some embodiments, the web portal 124 may include a communication hub, which enables direct messaging between patrons 138 and property management 140 staff for inquiries, complaints, or general communication and may support sending announcements, alerts, and updates to all patrons 138. In some embodiments, the web portal 124 may include a complaint management system, which allows patrons 138 to submit maintenance requests or complaints through a user-friendly interface, tracks the status of requests, assigns tasks to maintenance staff, and provides updates to patrons. In some embodiments, the web portal 124 may include property updates and notifications by displaying announcements, news, and updates regarding the property, community events, maintenance schedules, etc., through push notifications or email alerts to patrons 138 for important developments. In some embodiments, the web portal 124 may include HOA member feedback and survey forms for patrons 138 to provide input on their living experience and suggest improvements. In some embodiments, the web portal 124 may include account management, which allows patrons 138 to manage their profiles, update personal information, view transaction history, and provide a log of past interactions and activities within the portal. In some embodiments, the web portal 124 may be integrated with the property management software 132 to synchronize data, streamline administrative processes, and ensure real-time updates and data consistency across systems. The non-financial module 110 receives, at step 504, the non-financial data from patron 138. The non-financial module 110 may receive the non-financial data, such as the number of adults, number of children, age, employment status, if the patron 138 has a property complaint, if there has been a change in occupancy, education level, patron's 138 middle initial, phone number, political party affiliation if the Patron 138 responds to emails, phone calls, or texts, the patron's 138 email address, social media avatars, social media profiles, such as LinkedIn, Facebook, Instagram, etc. if the patron 138 owns an RV, the number of vehicles, age, family size, years of employment, etc. The non-financial module 110 stores, at step 506, the non-financial data in the non-financial database 118. The non-financial database 118 may contain the patron's 138 non-financial information, such as the patron ID, first name, last name, address, number of adults, number of children, age, employment status, if the patron 138 has a property complaint, if there has a been a change in occupancy, etc. In some embodiments, the non-financial database 118 may include education level, patron's 138 middle initial, phone number, political party affiliation, if the Patron 138 responds to emails, phone calls, or texts, the patron's 138 email address, social media avatars, social media profiles, such as LinkedIn, Facebook, Instagram, etc., if the patron 138 owns an RV, the number of vehicles, age, family size, years of employment, etc. The non-financial module 110 returns, at step 508, to the base module 104.

FIG. 6 illustrates the interaction module 112. The process begins with the interaction module 112 being initiated by the base module 104. The interaction module 112 filters, at step 602, the financial database 116 on the first patron 138. The interaction module 112 may filter the financial database 116 on the first patron 138 so that the financial database 116 displays the individual patron's 138 data, such as first name, last name, address, home equity, the estimated value of the home, the patron's monthly invoices stored as a data file, the patron's 138 payment history, and the patron's 138 account status. The interaction module 112 extracts, at step 604, the patron's 138 data from the financial database 116. The interaction module 112 extracts the data, such as first name, last name, address, home equity, the estimated value of the home, the patron's monthly invoices stored as a data file, the patron's 138 payment history, and the patron's 138 account status. The interaction module 112 filters, at step 606, the non-financial database 118 on the extracted patron's 138 ID from the financial database 116. The interaction module 112 filters the non-financial database 118 on the extracted patron's 138 ID to display the patron's 138 non-financial data, such as number of adults, number of children, age, employment status, if the patron 138 has a property complaint, if there has a been a change in occupancy, etc. The interaction module 112 extracts, at step 608, the patrons 138 non-financial data from the non-financial database 118. The interaction module 112 extracts the patron's 138 non-financial data, such as the number of adults, number of children, age, employment status, if the patron 138 has a property complaint, if there has been a change in occupancy, etc. In some embodiments, the interaction module 112 may extract education level, patron's 138 middle initial, phone number, political party affiliation, if the Patron 138 responds to emails, phone calls, or texts, the patron's 138 email address, social media avatars, social media profiles, such as LinkedIn, Facebook, Instagram, etc., if the patron 138 owns an RV, the number of vehicles, age, family size, years of employment, etc. The interaction module 112 creates, at step 610, the interacting data for patron 138. For example, the interaction module 112 may utilize a decision tree algorithm to create the interacting data. The decision tree algorithm may be a computational method for predictive modeling and classification tasks within a computing environment. The algorithm may operate by recursively partitioning a dataset into subsets based on input features to maximize the homogeneity of outcome labels within each partition. At each step of the partitioning process, the algorithm selects the optimal feature and corresponding threshold to split the dataset, employing criteria such as information gain or Gini impurity to measure the effectiveness of candidate splits. The resulting decision tree structure consists of nodes representing decision points and edges representing feature-value conditions, forming a hierarchical tree structure. The algorithm may further incorporate mechanisms for pruning and regularization to mitigate overfitting and enhance generalization performance. During inference, input data instances traverse the decision tree structure, with each node applying the corresponding feature-value condition to guide the traversal until a leaf node is reached, where the associated outcome label is assigned. Through its systematic approach to feature selection and partitioning, the decision tree algorithm may facilitate interpretable and efficient predictive modeling across various domains, including property management and financial analysis. For example, financial data, including payment history and account status, and non-financial data, including employment status, may be collected by extracting the information from the financial database 116 and non-financial database 118. Then, the algorithm may define the features, such as last payment status and employment status, and assign labels based on the desired outcome, such as a recently lost job or recently retired. The assigned label may be further associated with the root cause for the assignment.

The decision tree algorithm may be trained using the collected data, with features, such as last payment status, employment status, etc., as inputs and the labeled outcomes, such as recently lost job, retired, etc., as target labels. The algorithm may communicate with third-party servers, internal systems, or third party software applications via application programming interface (API) to obtain the training data. Data regarding credit history, bankruptcy status, whether or not an account is delinquent, historical ledger, demographic data, income, employment, payment data of homeowners, collection effort employed, legal processes taken, characteristics identified during collections processes including communications, communication methods, and corresponding responses, rate of responses from the accounts, and operational data from accounts associated with proprietary software applications, third party servers, or internal systems may be obtained as training data. The algorithm may filter accounts with complete feature and outcome history to use as training data, at the same time, exclude accounts with missing critical features or ambiguous resolution outcomes. The accounts with ambiguous resolution may be excluded from training data, marked with “label_error.” The system may track the account to determine that a concrete resolution is reached on the account, then update the label and include the account in the training data. The accounts with ambiguous data may be flagged for human review and its label may be updated at a later time. The accounts with a record of accompanying actions taken may be further used in the action module to determine the actions to be taken in association with the assigned labels.

The algorithm may construct a decision tree by recursively splitting the data based on the features that best separate the labeled outcomes. For example, it may split the data based on whether the last payment is unpaid and whether the member is unemployed. The trained decision tree model may be evaluated using validation data to assess its accuracy and performance. Updates in the input data in real-time may update the decision tree algorithm. Metrics such as accuracy, precision, recall, and F1-score may be computed to evaluate the model's performance in predicting the labeled outcomes. The decision tree may be continuously updated by the new training data, filter out anomalous data, and rerun with the training data after the anomalous data is filtered out.

Once the algorithm is trained and validated, the decision tree model can be used to predict outcomes for new data instances. For example, given a patron's 138 financial data, such as the last payment unpaid, and non-financial data such as unemployment, the decision tree may predict that the member recently lost their job. Given a patron's 138 account status, such as delinquent due to late payments, and non-financial data, such as age being 68 and a decrease in income, the decision tree may predict that the patron 138 recently retired. The predicted outcomes may be stored and used to as inputs in a feedback loop to refine and update the decision tree algorithm. The system may track the actual outcome of the patron in a different period of time, compare the actual outcome with the predicted outcome, and update the label assigned to the patron based on the actual outcome. The actual outcome may then be stored and used to as inputs in a feedback loop to refine and update the decision tree algorithm. The algorithm may filter out data regarding the patron depending on the comparison between the actual and predicted outcomes such that the predicted label of the patron that is different from the actual outcome may not be used in the decision tree algorithm.

The interaction module 112 stores, at step 612, the interacting data in the interaction database 120. The interaction database 120 may include the patron's ID, the financial data point, the non-financial data point, and the interacting data point. In some embodiments, the financial data point may be the patron's 138 home equity, the estimated value of the home, the patron's monthly invoices stored as a data file, the patron's payment history, the patron's 138 account status, disposable income, liquid assets, income, debt range, debt utilization, etc. In some embodiments, the non-financial data point may be number of adults, number of children, age, employment status, if the patron 138 has a property complaint, if there has a been a change in occupancy, education level, patron's 138 middle initial, phone number, political party affiliation, if the Patron 138 responds to emails, phone calls, or texts, the patron's 138 email address, social media avatars, social media profiles, such as LinkedIn, Facebook, Instagram, etc., if the patron 138 owns an RV, the number of vehicles, age, family size, years of employment, etc. Any updates, changes, or new information in the patron's data in the interaction database may trigger updating the model with the new information. Such changes may update the assigned label or assign an additional new label. The changes may be payment events, signed plan agreements, outcome from the communication with the device associated with the account, legal milestone completions, negative events (bounce, wrong-number).

The interaction module 112 determines, at step 614, if there are more patrons 138 remaining in the financial database 116. The interaction module 112 may filter the financial database 116 on each patron 138 to ensure that each patron's 138 account has the interacting data created to store the interacting data of each patron 138 in the interaction database 120. If it is determined that there are more patrons 138 remaining in the financial database 116 the interaction module 112 filters, at step 616, the financial database 116 on the next patron 138. If it is determined that there are no more patrons 138 remaining in the financial database 116, the interaction module 112 returns, at step 618, to the base module 104.

FIG. 7 illustrates the action module 114. The process begins with the action module 114 being initiated by the base module 104. The action module 114 filters, at step 702, the interaction database 120 on the first patron 138. The action module 114 may filter the interaction database 120 on the first patron 138 so that the interaction database 1 displays the individual patron's 138 data, such as financial data point, non-financial data point, and the created interacting data point. The action module 114 extracts, at step 704, the patron's 138 data from the interaction database 120. The patron's data may be collected from a plurality of third party servers communicating with the platform over a communication network via API. The action module 114 may extract the patron's 138 data, such as the patron's ID, the financial data point, the non-financial data point, and the interacting data point. In some embodiments, the financial data point may be the patron's 138 home equity, the estimated value of the home, the patron's monthly invoices stored as a data file, the patron's payment history, the patron's 138 account status, disposable income, liquid assets, income, debt range, debt utilization, etc. In some embodiments, the non-financial data point may be number of adults, number of children, age, employment status, if the patron 138 has a property complaint, if there has a been a change in occupancy, education level, patron's 138 middle initial, phone number, political party affiliation, if the Patron 138 responds to emails, phone calls, or texts, the reply rate of the account, the patron's 138 email address, social media avatars, social media profiles, such as LinkedIn, Facebook, Instagram, etc., if the patron 138 owns an RV, the number of vehicles, age, family size, years of employment, etc. Based on the extracted data from the patron, the patron may be assigned a label.

The action module 114 compares, at step 706, the extracted data and the assigned label to the action database 122. The action database 122 may be a previously created or existing database that contains a plurality of rules that are used in the action module 114 to determine if there is a corresponding action or notification that needs to be sent to a patron 138. The action database 122 may contain a rule ID, the rule, and the corresponding action. The rules may be used to determine if there is a potential issue with a patron's 138 account based on the interacting data created in the interaction module 112 and provide an action to adjust the patron's 138 payment plan, send a notification, expedite maintenance on the property, etc. In some embodiments, the rules may be based on the specific situation that the Patron 138 is experiencing. In some embodiments, the rules may adjust the payment plan of the patron 138 to provide financial flexibility depending on the patron's 138 current situation. In some embodiments, the corresponding actions may range from no action, extending the payment plan, waiving the payments required by the patron 138, to determining how the patron 138 is contacted. In some embodiments, the label assigned to the account may be updated based on the user response to an action is performed on an account. For example, if the account shows high response rate via SMS messages and provides a promise to pay in response to the notification sent to the account, assuming a low outstanding balance on the account, the account may be labeled as resolved, taking no further action. The label may further include the root cause of the label, such as a recent positive engagement or fulfilled payment. In another example, account having a prior legal state stage, no recent communication from the account, and a high remaining balance may be flagged as high risk and further action to be taken.

The action module 114 determines, at step 708, if there is a corresponding action. For example, if the patron's 138 interacting data is that they recently lost their job or employment, based on the patron 138 account balance is outstanding and they are unemployed, the action may be to extend the payment plan by three months. If the patron's 138 interacting data is that they recently retired, based on the patron's 138 age and reduction of income, and has a recent late payment, the action may be to contact the patron 138 about their payment plan due to the lifestyle change. If the patron's 138 interacting data is that they recently separated from the partner, based on their account status being up-to-date and a change in occupancy at the property, the action may be to extend the payment plan by five months. If the patron's 138 interacting data is that their account is satisfactory, meaning payments are up-to-date, and there is no change in non-financial data, then the corresponding action may be no action.

If it is determined that there is a corresponding action in the action database 122, the action module 114 extracts, at step 710, the corresponding action. The action module 114 may extract the corresponding action, such as no action, extending the payment plan, waiving the payments required by patron 138, and how patron 138 is contacted. The action module 114 executes, at step 712, the corresponding action. For example, the action module 114 may execute the action, such as no action, extending the payment plan, waiving the payments required by the patron 138, how the patron 138 is contacted, removing late fees, sending payment reminders a week before the payment due date, send re-payment plan options to the patron 138, contact the patron to discuss issues, etc. through the property management software 132 or via the web portal 124 and notification system 130 of the property platform 102.

The action module may update the action to be taken based on any updates, changes, or new information in the patron's data or changes in the label or assignment of a new label, or new event relevant to the patron account. Such changes may be payment events, signed plan agreements, outcome from the communication with the device associated with the account, legal milestone completions, negative events (bounce, wrong-number). The changes or new information to the patron account may trigger updating the action to be executed for the account.

If it is determined that there is not a corresponding action or after the extracted corresponding action has been executed, the action module 114 determines, at step 714, if there are more patrons 138 remaining in the interaction database 120. If it is determined that there are more patrons 138 remaining in the interaction database 120, the action module 114 filters, at step 716, the interaction database 120 on the next patron 138, and the process returns to extracting the patron's 138 data from the interaction database 120. If it is determined that there are no more patrons 138 remaining in the interaction database 120, the action module 114 returns, at step 718, to the base module 104.

Table 1 below illustrates the financial database 116. The financial database 116 may be a database created in the process described in the accounting module 106 and the Accounts module 108 in which the patron's 138 finances are collected and/or calculated. The financial database 116 may contain the patron's 138 financial information, such as the patron ID, first name, last name, address, home equity, the estimated value of the home, the patron's monthly invoices stored as a data file, the patron's payment history, and the patron's account status. In some embodiments, the financial database 116 may contain the patron's city, state, zip code, disposable income, liquid assets, income, debt range, debt utilization, etc.

TABLE 1

| Patron | First | Last | | Home | Estimated | | | |
|---|---|---|---|---|---|---|---|---|
| ID | Name | Name | Address | Equity | Value | Monthly Statement | Payment | Account Status |
| JD123 | John | Doe | 123 Main St | $200,000 | $300,000 | JD123.AugustInvoice.data | Not Paid | Delinquent- Outstanding Balance |
| | | | | | | JD123JulyInvoice.data | Late | Delinquent- Late Fee |
| | | | | | | JD123JunetInvoice.data | Late | Delinquent- Late Fee |
| JS321 | Jane | Smith | 456 Elm St | $150,000 | $250,000 | JS321AugustInvoice.Data | Late | Delinquent- Late Fee |
| | | | | | | JS321JulyInvoice.Data | Late | Delinquent- Late Fee |
| | | | | | | JS321JuneInvoice.Data | On-Time | Up-to-Date |
| DJ789 | David | Johnson | 789 Oak St | $180,000 | $250,000 | DJ789AugustInvoice.Data | On-Time | Up-to-Date |
| | | | | | | DJ789JulyInvoice.Data | On-Time | Up-to-Date |
| | | | | | | DJ789JuneInvoice.Data | On-Time | Up-to-Date |
| EB101 | Emily | Brown | 101 Pine St | $220,000 | $350,000 | EB101AugustInvoice.Data | On-Time | Up-to-Date |
| | | | | | | EB101JulyInvoice.Data | Late | Up-to-Date |
| | | | | | | EB101JuneInvoice.Data | On-Time | Up-to-Date |
| — | — | — | — | — | — | — | — | — |
| — | — | — | — | — | — | — | — | — |
| — | — | — | — | — | — | — | — | — |

Table 2 below illustrates the non-financial database 118. The non-financial database 118 may be a database created in the process described in the non-financial module 110 in which the patron's 138 non-financial is collected. The non-financial database 118 may contain the patron's 138 non-financial information, such as the patron ID, first name, last name, address, number of adults, number of children, age, employment status, if the patron 138 has a property complaint, if there has a been a change in occupancy, etc. In some embodiments, the non-financial database 118 may include education level, patron's 138 middle initial, phone number, political party affiliation, if the Patron 138 responds to emails, phone calls, or texts, the patron's 138 email address, social media avatars, social media profiles, such as LinkedIn, Facebook, Instagram, etc., if the patron 138 owns an RV, the number of vehicles, age, family size, years of employment, etc.

TABLE 2

| Patron | First | Last | | | # of | # of | Employment | Property | Change in |
|---|---|---|---|---|---|---|---|---|---|
| ID | Name | Name | Address | Age | Adults | Children | States | Complaints | Occupancy |
| JD123 | John | Doe | 123 Main St | 36 | 2 | 1 | Unemployed | No | No |
| JS321 | Jane | Smith | 456 Elm St | 68 | 1 | 0 | Decrease in income | No | No |
| DJ789 | David | Johnson | 789 Oak St | 45 | 1 | 2 | Employed | No | Yes |
| EB101 | Emily | Brown | 101 Pine St | 32 | 2 | 0 | Employed | No | No |
| — | — | — | — | | — | — | — | — | — |
| — | — | — | — | | — | — | — | — | — |
| — | — | — | — | | — | — | — | — | — |

Table 3 below illustrates the interaction database 120. The interaction database 120 may be created during the process described in the interaction module 112 in which a financial data point and non-financial data point are used to create interacting data that is used in the action module 114 to determine if there should be an adjustment to the patron's 138 payments or account. The interaction database 120 may include the patron's ID, the financial data point, the non-financial data point, and the interacting data point. In some embodiments, the financial data point may be the patron's 138 home equity, the estimated value of the home, the patron's monthly invoices stored as a data file, the patron's payment history, the patron's 138 account status, disposable income, liquid assets, income, debt range, debt utilization, etc. In some embodiments, the non-financial data point may be number of adults, number of children, age, employment status, if the patron 138 has a property complaint, if there has a been a change in occupancy, education level, patron's 138 middle initial, phone number, political party affiliation, if the Patron 138 responds to emails, phone calls, or texts, the patron's 138 email address, social media avatars, social media profiles, such as LinkedIn, Facebook, Instagram, etc., if the patron 138 owns an RV, the number of vehicles, age, family size, years of employment, etc.

TABLE 3

| ID | Financial Data | Non-Financial Data | Interacting Data |
|---|---|---|---|
| JD123 | Last Payment - Unpaid | Unemployed | Recent Job Loss |
| JS321 | Account Status - Delinquent - Late Payments | Decrease in Income and Age | Recently Retired |
| DJ789 | Account Up-to-Date | Change in Occupancy | Recent Partner Separation |
| EB101 | Account Up-to-Date | Employed | Account Satisfactory |
| — | — | — | — |
| — | — | — | — |
| — | — | — | — |

Table 4 below illustrates the action database 122. The action database 122 may be a previously created or existing database that contains a plurality of rules that are used in the action module 114 to determine if there is a corresponding action or notification that needs to be sent to a patron 138. The action database 122 may contain a rule ID, the rule, and the corresponding action. The rules may be used to determine if there is a potential issue with a patron's 138 account based on the interacting data created in the interaction module 112 and provide an action to adjust the patron's 138 payment plan, send a notification, expedite maintenance on the property, etc. In some embodiments, the rules may be based on the specific situation that the Patron 138 is experiencing. In some embodiments, the rules may adjust the payment plan of the patron 138 to provide financial flexibility depending on the patron's 138 current situation. In some embodiments, the corresponding actions may range from no action, extending the payment plan, waiving the payments required by the patron 138, to determining how the patron 138 is contacted. For example, if the patron's 138 interacting data is that they recently lost their job or employment, based on the patron 138 account balance is outstanding and they are unemployed, the action may be to extend the payment plan by three months. If the patron's 138 interacting data is that they recently retired, based on the patron's 138 age and reduction of income, and has a recent late payment, the action may be to contact the patron 138 about their payment plan due to the lifestyle change. If the patron's 138 interacting data is that they recently separated from the partner, based on their account status being up-to-date and a change in occupancy at the property, the action may be to extend the payment plan by five months. If the patron's 138 interacting data is that their account is satisfactory, meaning payments are up-to-date, and there is no change in non-financial data, then the corresponding action may be no action.

TABLE 4

| Rule ID | Rule | Action |
|---|---|---|
| Emp-001 | Patron Lost Employment or Source of Income | Extend Payment Plan by 3 Months |
| Ret-345 | Patron Has Retired | Contact Patron About Payment Plan |
| Sep-987 | Patron Has Recently Separated with Partner | Extend Payment Plan by 5 Months |
| Sat-231 | Patron Account Satisfactory | No Action |
| — | — | — |
| — | — | — |
| — | — | — |

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. A method for integrating disparate data structures, the method comprising:
storing a plurality of rules and corresponding actions to the rules;
receiving data of a user account over a communication network;
extracting one or more features from the received data, wherein the features are associated with threshold conditions;
analyzing the received data using recursive modeling to predict a label associated with the account based on the extracted features achieving the threshold conditions;
comparing the label of the analyzed data to the stored rules; and
executing an action based on the comparison, wherein the action includes automatically adjusting a current plan of the user account.

2. The method of claim 1, further comprising training the recursive modeling based on a dataset associated with a plurality of user accounts.

3. The method of claim 2, wherein the dataset is partitioned into subsets based on features associated with the received data.

4. The method of claim 2, further comprising:
generating a hierarchical decision tree structure by training a decision tree model, wherein the model splits the dataset based on a threshold conditions of each feature;
assigning an outcome label based on reaching a node in the decision tree structure; and
updating the model based on an accuracy score.

5. The method of claim 4, wherein updating the model further based on updates to the dataset associated with the plurality of user accounts.

6. The method of claim 1, further comprising updating the model based on a comparison between the predicted label and an actual outcome.

7. The method of claim 1, further comprising updating the label based on an updated data of the user.

8. The method of claim 7, further comprising updating the action based on an updated label.

9. The method of claim 1, wherein the data of the user account is received from one or more third party servers.

10. The method of claim 1, further comprising updating the label of the account in response to a user reply to the executed action.

11. A system for integrating disparate data structures, the system comprising:
memory that stores a plurality of rules and corresponding actions to the rules;
a communication interface that communicates over a communication network to receive receiving data of a user account; and
a processor that executes instructions stored in memory, wherein the processor executes the instructions to:
extract one or more features from the received data, wherein the features are associated with threshold conditions;
analyze the received data using recursive modeling to predict a label associated with the account based on the extracted features achieving the threshold conditions;
compare the label of the analyzed data to the stored rules; and
execute an action based on the comparison, wherein the action includes automatically adjusting a current plan of the user account.

12. The system of claim 11, wherein the processor executes further instructions to train the recursive modeling based on a dataset associated with a plurality of user accounts.

13. The system of claim 12, wherein the dataset is partitioned into subsets based on features associated with the received data.

14. The system of claim 12, wherein the processor executes further instructions to:
generate a hierarchical decision tree structure by training a decision tree model, wherein the model splits the dataset based on a threshold conditions of each feature;
assign an outcome label based on reaching a node in the decision tree structure; and
update the model based on an accuracy score.

15. The system of claim 14, wherein updating the model further based on updates to the dataset associated with the plurality of user accounts.

16. The system of claim 11, wherein the processor executes further instruction to update the model based on a comparison between the predicted label and an actual outcome.

17. The system of claim 11, wherein the processor executes further instruction to update the label based on an updated data of the user.

18. The system of claim 17, wherein the processor executes further instruction to update the action based on an updated label.

19. The system of claim 11, wherein the processor executes further instruction to update the label of the account in response to a user reply to the executed action.

20. A non-transitory, computer-readable storage medium, having embodied thereon a program executable by a processor to perform a method for integrating disparate data structures, the method comprising:
storing a plurality of rules and corresponding actions to the rules;
receiving data of a user account over a communication network;
extracting one or more features from the received data, wherein the features are associated with threshold conditions;
analyzing the received data using recursive modeling to predict a label associated with the account based on the extracted features achieving the threshold conditions;
comparing the label of the analyzed data to the stored rules; and
executing an action based on the comparison, wherein the action includes automatically adjusting a current plan of the user account.
